(19) United States
(12) Patent Application Publication
(10) Pub. No.: US 2015/0234828 A1
(43) Pub. Date: Aug. 20, 2015

(54) ADDRESS BOOK SORTING METHOD AND SYSTEM OF MOBILE TERMINAL

(71) Applicant: ZTE CORPORATION, Shenzhen City (CN)

(72) Inventors: Qinbo Huang, Shenzhen City (CN); Benquan Zhang, Shenzhen City (CN); Sheng Zhong, Shenzhen City (CN)

(21) Appl. No.: 14/421,573

(22) PCT Filed: Jun. 9, 2013
(86) PCT No.: PCT/CN2013/077083

§ 371 Date: Feb. 13, 2015

(30) Foreign Application Priority Data
Aug. 17, 2012 (CN) 201210293431.2

(51) Int. Cl. G06F 17/30; H04W 4/02

(52) U.S. Cl. CPC G06F 17/3053; H04W 4/025

(57) ABSTRACT

A method and system for ranking an address book of a mobile terminal are provided. The method includes: acquiring location information of the terminal; comparing the location information of the terminal with places to which corresponding telephone numbers in the address book belong one by one, and selecting a corresponding telephone number that belongs to a place matched with the location information of the terminal; and placing information of a contact person to which the selected telephone number belongs at the top of the address book. With the method and the system, it is more convenient for a terminal user to acquire a means of communication of a contact person in a place where the user arrives.

### CROSS-REFERENCE TO RELATED APPLICATIONS

This application is the 35 U.S.C. §371 national stage of PCT Application No. PCT/CN2013/077083, filed Jun. 9, 2013, which is herein incorporated by reference in its entirety and which also claims priority to, and the benefit of, Chinese Patent Application No. 201210293431.2, filed Aug. 17, 2012, which is herein incorporated by reference in its entirety.

### TECHNICAL FIELD

The present document relates to the field of mobile communications, and in particular, to a method and system for ranking an address book of a mobile terminal.

### BACKGROUND OF THE RELATED ART

The address book is one of basic applications of a mobile terminal such as a mobile phone etc., and is used for storing information such as telephone numbers of contact persons etc. At present, an order of ranking contact persons in the address book is generally an order of initial letters of names of the contact persons in the alphabet.

This ranking manner is inconvenient in daily life. For example, if a user of a mobile terminal is on a business trip, after the user arrives at the destination, the user searches the address book for telephone numbers of local contact persons. According to the current ranking manner in the address book, the user may need to spend some time to find the telephone numbers of the required contact persons, and if there is more than one required contact person, the user will spend a lot of time on searching for the telephone numbers.

Then, for the case described above, there is a problem of how to bring more convenience to the user of the mobile terminal by ranking the information of contact persons in the address book.

### SUMMARY

The embodiments of the present invention provide a method and system for ranking an address book of a mobile terminal, to solve the technical problem of how to enable the user of the mobile terminal to more conveniently acquire a means of communication of a contact person in a place where the user arrives.

The embodiments of the present invention provide a method for ranking an address book of a mobile terminal, comprising:

the mobile terminal acquiring location information of the terminal;

the mobile terminal comparing the location information of the terminal with places to which corresponding telephone numbers in the address book belong one by one, and selecting a corresponding telephone number that belongs to a place matched with the location information of the terminal; and

the mobile terminal placing information of a contact person to which the selected telephone number belongs at the top of the address book.

Alternatively, the step of the mobile terminal acquiring location information of the terminal comprises:

the mobile terminal acquiring the location information of the terminal through a Global Positioning System (GPS).

Alternatively, the method further comprises:

after acquiring the location information of the terminal through the GPS, the mobile terminal checking whether the location information of the terminal is included in location information preset by the user, and when the location information of the terminal is included in the location information preset by the user, comparing the location information of the terminal with the places to which the corresponding telephone numbers in the address book belong one by one.

Alternatively, the step of the mobile terminal placing information of a contact person to which the selected telephone number belongs at the top of the address book comprises:

after selecting the telephone number, the mobile terminal transmitting a top placing inquiry message to the user; and

after receiving a top placing acknowledgement message from the user, the mobile terminal placing the information of the contact person to which the selected telephone number belongs at the top of the address book.

The embodiments of the present invention further provide a system for ranking an address book of a mobile terminal, comprising a location information module, a telephone number inquiry module, and a ranking module, wherein,

the location information module is configured to acquire location information of the terminal, and transmit the acquired location information of the terminal to the telephone number inquiry module;

the telephone number inquiry module is configured to compare the location information of the terminal transmitted by the location information module with places to which corresponding telephone numbers in the address book belong one by one, select a corresponding telephone number that belongs to a place matched with the location information of the terminal, and transmit the selected telephone number to the ranking module; and

the ranking module is configured to place information of a contact person to which the selected telephone number belongs at the top of the address book.

Alternatively, the location information module is configured to acquire the location information of the terminal by:

acquiring the location information of the terminal through a Global Positioning System (GPS).

Alternatively, the location information module is further configured to check whether the location information of the terminal is included in location information preset by the user after acquiring the location information of the terminal through the GPS, and when the location information of the terminal is included in the location information preset by the user, transmit the location information of the terminal to the telephone number inquiry module.

Alternatively, the ranking module is configured to place information of a contact person to which the selected telephone number belongs at the top of the address book by:

after receiving the selected telephone number, transmitting a top placing inquiry message to the user; and after receiving a top placing acknowledgement message from the user, placing the information of the contact person to which the selected telephone number belongs at the top of the address book.

With the above technical scheme, a contact person who is in the same place as the terminal is selected from the address book, and the information of the selected contact person is placed at the top of the address book, thereby facilitating the terminal user to more conveniently acquire a means of communication of a contact person in a place where the user arrives.

### BRIEF DESCRIPTION OF DRAWINGS

FIG. 1 is a flowchart of a method for ranking an address book of a mobile terminal according to the present embodiment; and

FIG. 2 is a diagram of constitution of a system for ranking an address book of a mobile terminal according to the present embodiment.

### PREFERRED EMBODIMENTS OF THE PRESENT INVENTION

The embodiments of the present invention will be described in detail below in conjunction with accompanying drawings. It should be illustrated that without a conflict, the embodiments in the present application and the features in the embodiments can be combined with each other randomly.

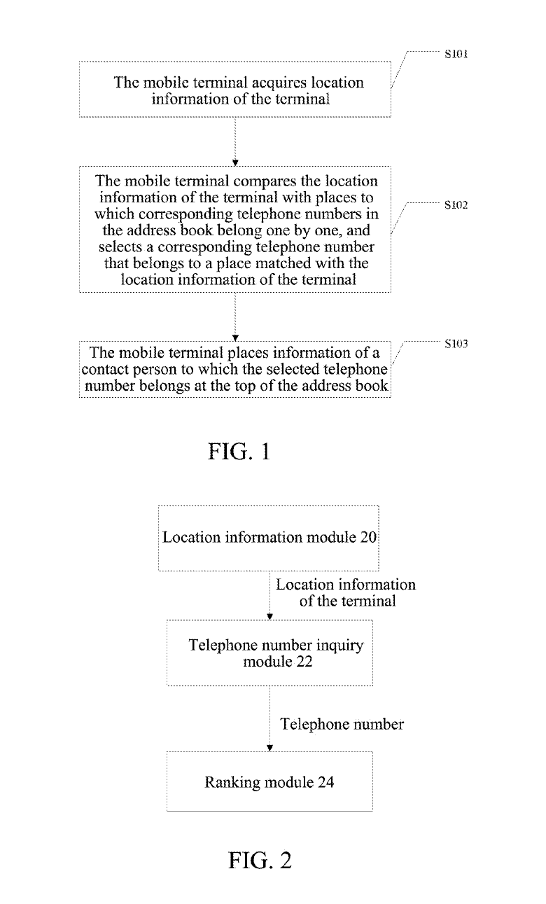

FIG. 1 is a flowchart of a method for ranking an address book of a mobile terminal according to the present embodiment. As shown in FIG. 1, the method comprises the following steps.

In step S101, the mobile terminal acquires location information of the terminal.

The mobile terminal may acquire the location information of the terminal through a Global Positioning System (GPS).

When the user wants to customize information of a contact person needed to be placed at the top in the address book according to the actual requirements of his/her own, the user may preset location information; after acquiring the location information of the terminal through the GPS, the mobile terminal checks whether the location information of the terminal is included in the location information preset by the user, and when the location information of the terminal is included in the location information preset by the user, step S102 continues to be performed.

In step S102, the mobile terminal compares the location information of the terminal with places to which corresponding telephone numbers in the address book belong one by one, and selects a corresponding telephone number that belongs to a place matched with the location information of the terminal.

In step S103, the mobile terminal places information of a contact person to which the selected telephone number belongs at the top of the address book.

After selecting the telephone number, the mobile terminal may transmit a top placing inquiry message to the user; and after receiving a top placing acknowledgement message from the user, the mobile terminal may place the information of the contact person to which the selected telephone number belongs at the top of the address book.

The above method of acquiring the location information of the terminal, selecting the telephone number using the location information of the terminal, and placing the selected telephone number at the top may also be applied to ranking the call records and short message records including telephone numbers.

The above embodiment will be described below by taking two application examples.

### Application Example One

A terminal departs from “Chengdu in SiChuan” to arrive at “Mianyang in Sichuan” via

“Deyang in Sichuan”. The process includes the following steps.

In step one, the mobile terminal starts a GPS.

In step two, the mobile terminal acquires location information of “Chengdu in Sichuan” through the GPS.

In step three, the mobile terminal compares the location information of “Chengdu in Sichuan” with places to which corresponding telephone numbers in an address book belong one by one, and selects a telephone number that belongs to the place of “Chengdu in Sichuan”.

In step four, the mobile terminal places the information of a contact person to which the telephone number belonging to the place of “Chengdu in Sichuan” belongs at the top of the address book.

In step five, the mobile terminal moves from “Chengdu in Sichuan” to “Deyang in Sichuan”, and acquires location information of “Deyang in Sichuan” through the GPS.

In step six, the mobile terminal compares the location information of “Deyang in Sichuan” with places to which corresponding telephone numbers in an address book belong one by one, and selects a telephone number that belongs to the place of “Deyang in Sichuan”.

In step seven, the mobile terminal places the information of a contact person to which the telephone number belonging to the place of “Deyang in Sichuan” belongs at the top of the address book.

In step eight, the mobile terminal moves from “Deyang in Sichuan” to “Mianyang in Sichuan”, and acquires location information of “Mianyang in Sichuan” through the GPS.

In step nine, the mobile terminal compares the location information of “Mianyang in Sichuan” with places to which corresponding telephone numbers in an address book belong one by one, and selects a telephone number which belongs to the place of “Mianyang in Sichuan”.

In step ten, the mobile terminal places the information of a contact person to which the telephone number belonging to the place of “Mianyang in Sichuan” belongs at the top of the address book.

### Application Example Two

A terminal departs from “Chengdu in SiChuan” to arrive at “Mianyang in Sichuan” via “Deyang in Sichuan”. However, the user only desires to acquire the information of the local contact person at the start place and at the destination. The process includes the following steps.

In step one, the mobile terminal starts a GPS, and at the same time, sets the city of a contact person which is required to be placed at the top as “Chengdu in Sichuan” and “Mianyang in Sichuan”.

In step two, the mobile terminal acquires location information of “Chengdu in Sichuan” through the GPS.

In step three, the mobile terminal compares the location information of “Chengdu in Sichuan” with the information set in step one, and finds that the location information of “Chengdu in Sichuan” is included in the information set in step one, and the mobile terminal compares the location information of “Chengdu in Sichuan” with places to which corresponding telephone numbers in an address book belong one by one, and selects a telephone number that belongs to the place of “Chengdu in Sichuan”.

In step four, the mobile terminal places the information of a contact person to which the telephone number belonging to the place of “Chengdu in Sichuan” belongs at the top of the address book.

In step five, the mobile terminal moves from “Chengdu in Sichuan” to “Deyang in Sichuan”, and acquires location information of “Deyang in Sichuan” through the GPS.

In step six, the mobile terminal compares the location information of “Deyang in Sichuan” with the information set in step one, and finds that the location information of “Deyang in Sichuan” is not included in the information set in step one, and the mobile terminal will not select the telephone number that belongs to the place of “Deyang in Sichuan” from the address book.

In step seven, the mobile terminal moves from “Deyang in Sichuan” to “Mianyang in Sichuan”, and acquires location information of “Mianyang in Sichuan” through the GPS.

In step eight, the mobile terminal compares the location information of “Mianyang in Sichuan” with the information set in step one, and finds that the location information of “Mianyang in Sichuan” is included in the information set in step one, and the mobile terminal compares the location information of “Mianyang in Sichuan” with places to which corresponding telephone numbers in an address book belong one by one, and selects a telephone number that belongs to the place of “Mianyang in Sichuan”.

In step nine, the mobile terminal places the information of a contact person to which the telephone number belonging to the place of “Mianyang in Sichuan” belongs at the top of the address book.

FIG. 2 is a diagram of constitution of a system for ranking an address book of a mobile terminal according to the present embodiment.

The system includes a location information module 20, a telephone number inquiry module 22, and a ranking module 24, wherein,

the location information module 20 is configured to acquire location information of the terminal, and transmit the acquired location information of the terminal to the telephone number inquiry module 22;

the location information module 20 is configured to acquire the location information of the terminal by: acquiring the location information of the terminal through a Global Positioning System (GPS);

the location information module 20 is further configured to check whether the location information of the terminal is included in location information preset by the user after acquiring the location information of the terminal through the GPS, and when the location information of the terminal is included in the location information preset by the user, transmit the location information of the terminal to the telephone number inquiry module 22;

the telephone number inquiry module 22 is configured to compare the location information of the terminal transmitted by the location information module with places to which corresponding telephone numbers in the address book belong one by one, select a corresponding telephone number that belongs to a place matched with the location information of the terminal, and transmit the selected telephone number to the ranking module;

the ranking module 24 is configured to place information of a contact person to which the selected telephone number belongs at the top of the address book;

the ranking module 24 is configured to place information of a contact person to which the selected telephone number belongs at the top of the address book by: after receiving the selected telephone number, transmitting a top placing inquiry message to the user; and after receiving a top placing acknowledgement message from the user, placing the information of the contact person to which the selected telephone number belongs at the top of the address book.

A person having ordinary skill in the art should understand that all or a part of the steps in the above method can be implemented by programs instructing related hardware, and the programs can be stored in a computer readable storage medium, such as a read-only memory, a disk, or a disc etc. Alternatively, all or a part of the steps in the aforementioned embodiments can also be implemented with one or more integrated circuits. Accordingly, various modules/units in the aforementioned embodiments can be implemented in a form of hardware, or can also be implemented in a form of software functional modules. The embodiments of the present invention are not limited to any particular form of combination of hardware and software.

It should be illustrated that the present document can also have a variety of other embodiments. Without departing from the spirit and essence of the present document, those skilled in the art can make various corresponding changes and variations based on the embodiments of the present invention, but all these changes and variations should belong to the protection scope of the appended claims in the present document.

### INDUSTRIAL APPLICABILITY

With the above technical scheme, a contact person who is in the same place as the terminal is selected from the address book, and the information of the selected contact person is placed at the top of the address book, thereby facilitating the terminal user to more conveniently acquire a means of communication of a contact person in a place where the user arrives.

What is claimed is:

1. A method for ranking an address book of a mobile terminal, comprising:
the mobile terminal acquiring location information of the terminal;
the mobile terminal comparing the location information of the terminal with places to which corresponding telephone numbers in the address book belong one by one, and selecting a corresponding telephone number that belongs to a place matched with the location information of the terminal; and
the mobile terminal placing information of a contact person to which the selected telephone number belongs at the top of the address book.

2. The method according to claim 1, wherein, the step of the mobile terminal acquiring location information of the terminal comprises:
the mobile terminal acquiring the location information of the terminal through a Global Positioning System (GPS).

3. The method according to claim 2, further comprising:
after acquiring the location information of the terminal through the GPS, the mobile terminal checking whether the location information of the terminal is included in location information preset by the user, and when the location information of the terminal is included in the location information preset by the user, comparing the location information of the terminal with the places to which the corresponding telephone numbers in the address book belong one by one.

4. The method according to claim 1, wherein, the step of the mobile terminal placing information of a contact person to which the selected telephone number belongs at the top of the address book comprises:
after selecting the telephone number, the mobile terminal transmitting a top placing inquiry message to the user; and
after receiving a top placing acknowledgement message from the user, the mobile terminal placing the information of the contact person to which the selected telephone number belongs at the top of the address book.

5. A system for ranking an address book of a mobile terminal, comprising a location information module, a telephone number inquiry module, and a ranking module, wherein,
the location information module is configured to acquire location information of the terminal, and transmit the acquired location information of the terminal to the telephone number inquiry module;
the telephone number inquiry module is configured to compare the location information of the terminal transmitted by the location information module with places to which corresponding telephone numbers in the address book belong one by one, select a corresponding telephone number that belongs to a place matched with the location information of the terminal, and transmit the selected telephone number to the ranking module; and
the ranking module is configured to place information of a contact person to which the selected telephone number belongs at the top of the address book.

6. The system according to claim 5, wherein, the location information module is configured to acquire the location information of the terminal by:
acquiring the location information of the terminal through a Global Positioning System (GPS).

7. The system according to claim 6, wherein,
the location information module is further configured to, after acquiring the location information of the terminal through the GPS, check whether the location information of the terminal is included in location information preset by the user, and when the location information of the terminal is included in the location information preset by the user, transmit the location information of the terminal to the telephone number inquiry module.

8. The system according to claim 5, wherein, the ranking module is configured to place information of a contact person to which the selected telephone number belongs at the top of the address book by:
after receiving the selected telephone number, transmitting a top placing inquiry message to the user; and after receiving a top placing acknowledgement message from the user, placing the information of the contact person to which the selected telephone number belongs at the top of the address book.

9. The method according to claim 2, wherein, the step of the mobile terminal placing information of a contact person to which the selected telephone number belongs at the top of the address book comprises:
after selecting the telephone number, the mobile terminal transmitting a top placing inquiry message to the user; and
after receiving a top placing acknowledgement message from the user, the mobile terminal placing the information of the contact person to which the selected telephone number belongs at the top of the address book.

10. The method according to claim 3, wherein, the step of the mobile terminal placing information of a contact person to which the selected telephone number belongs at the top of the address book comprises:
after selecting the telephone number, the mobile terminal transmitting a top placing inquiry message to the user; and
after receiving a top placing acknowledgement message from the user, the mobile terminal placing the information of the contact person to which the selected telephone number belongs at the top of the address book.

11. The system according to claim 6, wherein, the ranking module is configured to place information of a contact person to which the selected telephone number belongs at the top of the address book by:
after receiving the selected telephone number, transmitting a top placing inquiry message to the user; and after receiving a top placing acknowledgement message from the user, placing the information of the contact person to which the selected telephone number belongs at the top of the address book.

12. The system according to claim 7, wherein, the ranking module is configured to place information of a contact person to which the selected telephone number belongs at the top of the address book by:
after receiving the selected telephone number, transmitting a top placing inquiry message to the user; and after receiving a top placing acknowledgement message from the user, placing the information of the contact person to which the selected telephone number belongs at the top of the address book.
